(19) United States
(12) Patent Application Publication
(10) Pub. No.: US 2012/0070172 A1
(43) Pub. Date: Mar. 22, 2012

(54) FUSER, AN IMAGE DORMING APPARATUS HAVING A FUSER AND A METHOD TOSTOP A ROATATION MEMBER

(75) Inventor: Hiroshi Ota, Tokyo-to (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/232,512

(22) Filed: Sep. 14, 2011

Related U.S. Application Data
(60) Provisional application No. 61/384,085, filed on Sep. 17, 2010.

(51) Int. Cl. G03G 15/20

(52) U.S. Cl. 399/67

(57) ABSTRACT

According to one embodiment, a fuser including an endless member, an endless section of which moves in a rotating direction of a rotating shaft according to rotation of the shaft, a pressing cylindrical member which applies predetermined pressure to the endless section of the endless member, and a controller configured to detect a rotation angle of the pressing cylindrical member, the controller detecting, with a rotation angle equivalent to a nip region where the pressing cylindrical member and the endless section comes into contact with each other and are elastically deformed set as a minimum unit of the rotation angle, a rotation angle for dividing an outer circumference of the pressing cylindrical member with an integer.

### CROSS-REFERENCE TO RELATED APPLICATIONS

This application is based upon and claims the benefit of priority from: U.S. Provisional Application No. 61/384,085 filed on Sep. 17, 2010, the entire contents of each of which are incorporated herein by reference.

### FILED

Embodiments described herein relate generally to a fuser, an image forming apparatus having a fuser and method to control circumference position of a roller of the fuser.

### BACKGROUND

In a group of MFPs (image forming apparatuses called Multi-Functional Peripheral) that use toner as a visualizing material, a fusing device that fuses the toner on a sheet medium is used.

The fusing device applies heat and pressure to the toner and the sheet medium and fuses the toner on the sheet medium. In order to apply pressure to the toner and the sheet medium, two rollers or the like come into contact with each other at predetermined pressure such that a nip is formed.

In the nip to which heat is applied, the material of elastic bodies (the rollers, etc.) for forming the nip is deteriorated. Therefore, the rollers or the like of the fusing device rotate at every fused time such that the nip moves. However, local deterioration of the material of the elastic bodies (the rollers) occurs in relation to accumulation of image formation. The local deterioration of the material of the elastic bodies (the rollers) is nothing but a factor of causing undesired abnormal sound during driving, a local fusing failure, and the like.

### BRIEF DESCRIPTION OF THE DRAWINGS

FIGS. 1A and 1B are exemplary diagrams showing an example of a fuser in an MFP (an image forming apparatus) according to an embodiment;

FIG. 2 is an exemplary diagram showing an example of a fuser according to an embodiment that determines in which section of press roller sections (positions), which are obtained by dividing a press roller outer circumference, many nip stop positions are present and uniformalizes the nip stop positions in all the sections;

FIG. 3 is an exemplary diagram showing an example of a method of controlling the nip stop positions to be uniform in all the sections;

FIG. 4 is an exemplary diagram showing an example of an MFP with a fuser according to an embodiment;

FIG. 5 is an exemplary diagram showing an example of a structure of a fuser according to an embodiment that informs the position (the angle) of a press roller for specifying the nip stop positions and the sections of the press roller outer circumference;

FIG. 6 is an exemplary diagram showing an example of a control block of an MFP according to an embodiment;

FIG. 7 is an exemplary diagram showing an example of a fuser according to an embodiment that determines in which section of press roller sections (positions), which are obtained by dividing a press roller outer circumference, many nip stop positions are present and uniformalizes the nip stop positions in all the sections;

FIG. 8 is an exemplary diagram showing an example of a fuser according to an embodiment; and

FIG. 9 is an exemplary diagram showing an example of a fuser according to an embodiment.

### DETAILED DESCRIPTION

In general, according to one embodiment, a fuser comprising: an endless member, an endless section of which moves in a rotating direction of a rotating shaft according to rotation of the shaft; a pressing cylindrical member which applies predetermined pressure to the endless section of the endless member; and a controller configured to detect a rotation angle of the pressing cylindrical member, the controller detecting, with a rotation angle equivalent to a nip region where the pressing cylindrical member and the endless section comes into contact with each other and are elastically deformed set as a minimum unit of the rotation angle, a rotation angle for dividing an outer circumference of the pressing cylindrical member with an integer.

Embodiments will now be described hereinafter in detail with reference to the accompanying drawings.

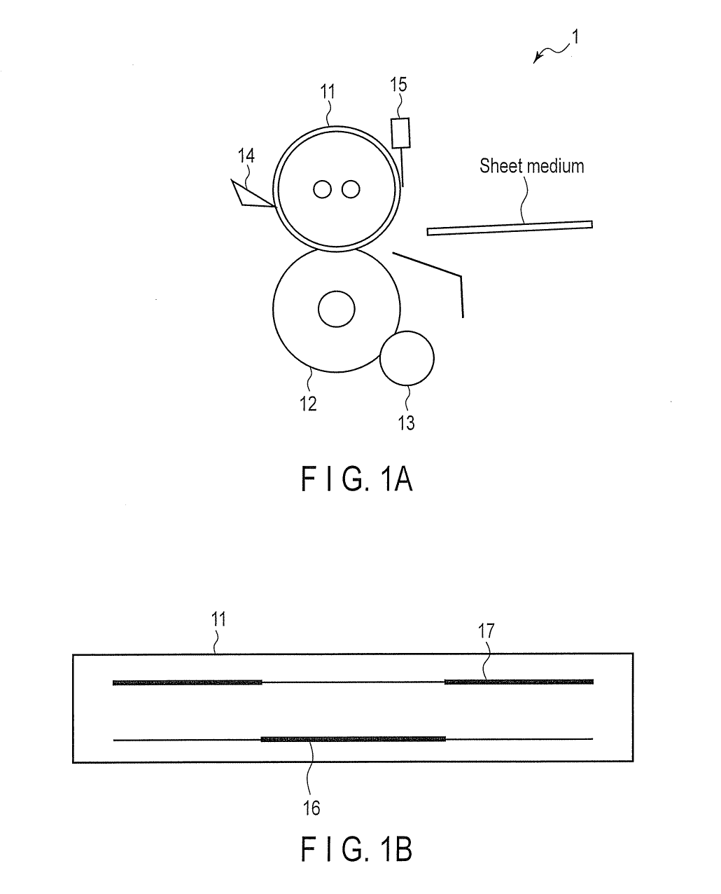

FIGS. 1A and 1B show an example of a fuser installed in an MFP (Multi-Functional Peripheral (an image forming apparatus)) of a type for using toner as a visualizing agent and configured to fuse the toner on a sheet material.

The fuser 1 includes at least a first roller 11 configured to rotate about a center shaft, a second roller 12 configured to rotate about a center shaft parallel to the center shaft of the first roller 11, a cleaning roller 13 configured to clean the surface of the second roller 12, a peeling pawl 14 configured to peel the sheet material off the first roller 11, and a thermistor 15 configured to detect outer circumferential temperature of the first roller 11.

The first roller 11 is, for example, a hollow roller of metal having a diameter of 30 mm and thickness of 0.8 mm. The first roller 11 has a peeling layer defined by, for example, tetrafluoroethylene resin on the outermost circumference. In most cases, the first roller 11 is called heat roller. When the toner is fused on the sheet material, the first roller 11 comes into contact with a surface of the sheet material on which the toner is located. The heat roller (the first roller) 11 includes, as shown in FIG. 1B, a center lamp (a center heater) 16 configured to raise mainly the temperature in the center and the vicinity in a longitudinal direction of the heat roller 11 and side lamps (end heaters) 17 configured to raise mainly the temperature at both ends in the longitudinal direction (regions from the center and the vicinity of the center to roller ends) of the heat roller 11.

The second roller 12 is a roller obtained by molding an elastic body such as silicon rubber or urethane rubber around a shaft (a center shaft) and setting a diameter to about 30 mm. The second roller 12 comes into contact with the heat roller 11 at predetermined pressure. In most cases, the second roller 12 is called press roller. When the toner is fused on the sheet material, the second roller 12 comes into contact with a surface of the sheet material on which the toner is not located (during image formation on the surface of the sheet material, the toner integrated with the sheet material could be present). The pressure between the heat roller 11 and the press roller 12 is, for example, 150 N (Newton).

In the fuser 1, control temperature of the outer circumferential surface of the heat roller 11 is 180° C. and circumferential speed (moving speed in a rotating direction of the outer circumferential surface per unit time (second)) of the heat roller 11 is 130 mm/s.

When the heat roller 11 and the press roller (the second roller) 12 come into contact with each other at the pressure of 150 N, a nip is formed in a region where both the rollers come into contact with each other. In the nip, usually, a dent is formed in the roller made of a softer material. Therefore, in the fuser 1 shown in FIGS. 1A and 1B, the dent due to the nip is formed mainly in the press roller 12. The dent leads to local deterioration of the material of the press roller 12.

For example, when warm-up after power-on ends or a predetermined time of an immediately preceding (last) image forming operation elapses, i.e., during ready standby (while the NFP is unattended), because of the pressure between the press roller 12 and the heat roller 11 and the heat of the heater lamps (the center lamp 16 and the side lamps 17), an arbitrary section (portion) of the press roller 12 including the width of the nip explained below is continuously exposed under conditions that are factors of the local deterioration.

Therefore, the outer circumferential length of the press roller 12 is imaginarily divided (sectioned) in a unit of an arbitrary section (portion) including the width of the nip. A cumulative total of heating time in each of divisions (sections) that stops in the nip is calculated. When the print (the image formation) ends or when the warm-up or pre-run in every fused period (rotation for a predetermined time in each fused period during non-image formation) ends, the press roller 12 is desirably stopped such that a section where the cumulative heating time is the smallest is a division (a section) that stops as the nip. When the cumulative heating rime is calculated, if the nip stops across two sections (adjacent to each other), heating times in the respective sections are accumulated.

According to this operation, heat deterioration in the circumferential direction (on the outer circumference) of the press roller 12 is substantially uniformalized. It is possible to prevent occurrence of a deficiency due to partial short life of the press roller 12. If a print volume (the number of times of image formation) is large, according to this operation, a traveling distance of the press roller 12 (which is a factor of wear of the peeling layer and the like on the outer circumferential surface due to an increase in the number of times of rotation) increases. Therefore, the same effect can also be obtained if the pre-run is carried out every time a determined time (time in which heat deterioration of the rubber of the press roller 12 in use is hardly accumulated, e.g., about one hour) elapses.

Further, if the press roller 12 does not rotate for a fused period in the ready standby (unattended) state, an operation for stopping the supply of power to the heater lamps is added, whereby it becomes less likely that the same portion is heated for a long period. Therefore, the heat deterioration prevention effect for the press roller rubber is further increased.

The width (the length on the circumference) of the nip depends on the material and the composition of the elastic body (the rubber), which is a main part of the press roller 12, presence or absence of air bubbles, and the like. The width is, for example, 4 mm to 5 mm. If the width of the nip is, for example, 4.5 mm, the width occupies about 4.8% (in angle indication, 17.2°, when approximated to an integer, 17°) of the outer circumferential length of the press roller 12 (about 94.2 mm calculated from the diameter of 30 mm). Therefore, a region where the outer circumference of the press roller 12 is locally deteriorated as the nip can be generally divided for each 17°.

Since the outer circumference of the press roller 12 is 360°, the number of divisions of the region where the outer circumference of the press roller 12 is locally deteriorated as the nip is 360/17=about 21.2. However, if a substantial method of control is taken into account, it is desirable to divide the region into 21 by approximating the number to an integer. If the width of the nip is 5 mm, the nip occupies about 5.3% (19.1°, when approximated to an integer, 19°) of the outer circumferential length of the press roller 12. In this case, the number of divisions is 360/19=about 18.9. It is desirable to divide the region into 19 by approximating the number to an integer.

Since the number of divisions (21 or 19) is an odd number, when the cumulative number of times of image formation increases, the center position of the nip moves little by little. Therefore, if even numbers close to the respective numbers of divisions are taken into account, the number of division is 20 or 18. If the number of divisions is large, it can be predicted that the nip is more often formed across two divisions adjacent to each other. Therefore, an example in which the number of divisions is set to 18 taking into account rationality of the substantial method of control is explained. Specifically, the number of divisions can be represented as an angle, with which the roller outer circumference can be equally divided into an integer number, and which is equivalent to the nip width equal to or larger than the width of the nip. This can also be represented as a number obtained by dividing the roller outer circumferential length into an even number integer, which is a distance at least larger than the width of the nip.

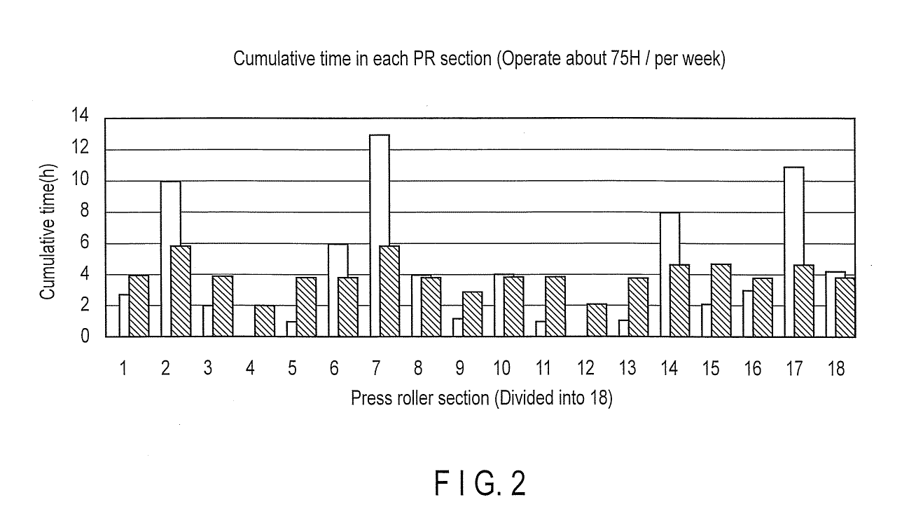

In FIG. 2, time in which each of divisions, which are obtained by dividing the outer circumference of the press roller into n (n is a positive integer, n=18), is located in the nip when the rotation ends (forms the nip when the rotation stops) is shown in each of cases in which the present proposal is applied and the present proposal is not applied.

It is seen from FIG. 2 that, if the present proposal is applied, a difference between a maximum time and a minimum time of a cumulative time in which the divisions of the press roller are located in the nip is 4 hours (about 5.3%) in a total operation time (75 hours). On the other hand, if the present proposal is not applied, the difference between the maximum time and the minimum time increases to 15 hours (about 20%) in the total operation time (75 hours).

In other words, by applying the present proposal, fluctuation in a degree of local deterioration of the outer circumference of the press roller 12 located in the nip is improved to about ¼ compared with the fluctuation that occurs when the present proposal is not applied.

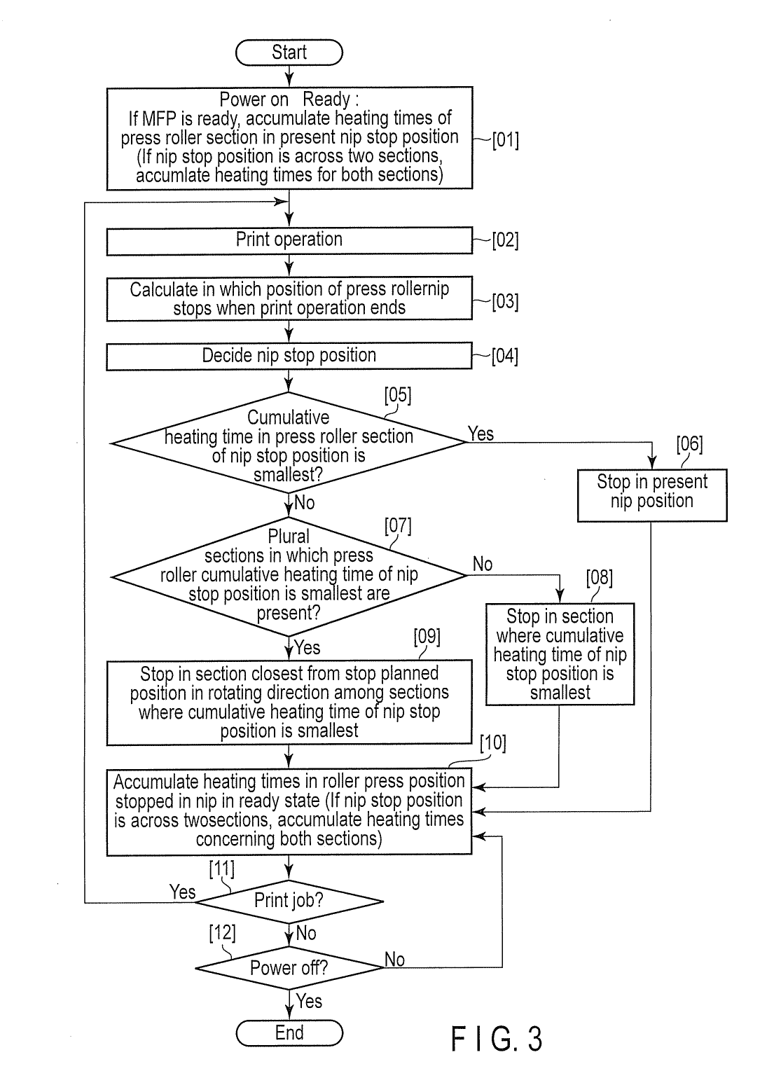

FIG. 3 shows an example in which the divisions during the stop of the press roller shown in FIG. 2 are controlled.

After power-on, if the MFP is ready, heating times in a press roller section (1 to n) in a position where the press roller stops in the present nip (hereinafter referred to as “nip stop position”) are accumulated [01]. The circumference of the press roller is equally divided by n (n is an integer and desirably an even number) into the sections 1 to n in the rotating direction from a reference position. If the nip stop position is across two sections, heating times are accumulated concerning both the sections.

After a printing (image forming) operation [02], it is calculated which position (section) of the press roller is the nip stop position when the printing operation ends [03].

The nip stop position (calculated in [03]) is decided [04]. It is checked whether the decided roller position (nip stop position (section)) is a position where the cumulative heating time of the press roller section (position) of the nip stop position is the smallest [05].

If the decided roller position (nip stop position (section)) is the position where the cumulative heating time of the press roller section (position) of the nip stop position is the smallest [05-YES], the press roller is directly stopped in the decided nip position [06].

If the decided roller position (nip stop position (section)) is not the position where the cumulative heating time of the press roller section (position) of the nip stop position is the smallest [05-NO], it is checked whether plural sections where the cumulative heating time of the press roller section (position) of the nip stop position is the smallest are present [07].

If plural sections where the cumulative heating time of the press roller section (position) of the nip stop position is the smallest are not present [07-NO], a position where the press roller is stopped is set such that a section where the cumulative heating time of the press roller section (position) in a nip position is the smallest is the nip stop position [08].

If plural sections where the cumulative heating time of the press roller section (position) of the nip stop position is the smallest are present [07-YES], a position where the press roller is stopped is set such that a section (a position) closest from a press roller (rotation) stop planned position in the rotating direction (downstream) is the nip stop position [09].

Heating times are accumulated concerning the position where the press roller stops. If the nip stop position is across two sections, heating times are accumulated concerning both the sections [10].

If no following print job is present [11-NO], a power supply for the heater lamps is turned off after a predetermined time elapses [12].

If the following print job is set within a fused time from the stop of the press roller, the accumulation of heating times being accumulated is stopped (canceled). This makes it possible to increase accuracy in associating cumulative heating time (a cumulative total of heating times) and a degree of local deterioration (heat deterioration) of the press roller.

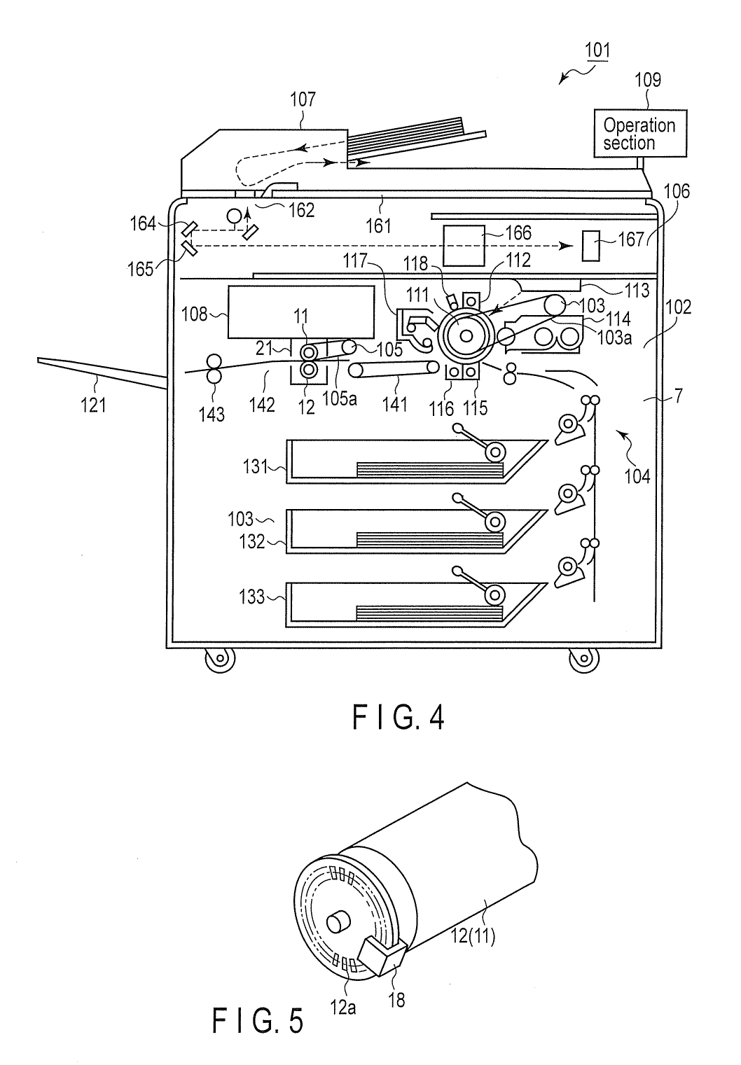

FIG. 4 shows an example of an array of the fuser in the MFP (Multi-Functional Peripheral (image forming apparatus)) including the fuser shown in FIGS. 1A and 1B.

An MFP 101 includes at least an image forming section 102, a sheet-medium retaining section 103, a sheet-medium feeding section 104, a fusing and sheet discharge section 105, an image-information reading section 106, an ADF (Automatic Document Feeder (a document feeding section)) 107, a control section (a controller) 108, and a UI (User Interface (an operation input section)) 109.

In the MFP 101 shown in FIG. 4, an image obtained by the image forming section 102 visualizing image information read by the image-information reading section 106 (a visualizing material image) is located on a sheet medium fed from the sheet-medium retaining section 103 through the sheet-medium feeding section 104. The visualizing material image located on the sheet medium is integrated with the sheet medium by the fusing and sheet discharge section 105 and moves to a tray 121.

Image information to be read moved by the ADF 107 changes to shading of light in a table 161 or a reading position 162 of the image-information reading section 106 and is made incident on a lens 166 via guiding mechanisms 163 to 165 and located in a reading device, for example, a CCD line sensor or a CMOS 167 through the lens 166. Therefore, the image information to be read is changed to an image signal corresponding to the image information by the CCD line sensor or the CMOS (the reading device) 167.

A sheet medium of a size conforming to a magnification and a size of the image information received by the UI (the operation input section) 109 is fed from any one of cassettes 131 to 133, which can feed m (m is a positive integer, e.g., m=3) kinds of sheet media having predetermined sizes, and moves from the sheet-medium retaining section 103 to the sheet-medium feeding section 104. The sheet medium moves from the sheet-medium feeding section 104 to the image forming section 102 according to formation timing of the visualizing material image formed by the image forming section 102.

In the image forming section 102, a visualizing material image prepared by a visualizing device 114 to correspond to a latent image generated by a photoconductive member 111 (having polarization charges, which generates fused charges according to charging from a charging device 112, on the basis of image light from an exposing device 113 conforming to an image signal is moved to the sheet medium by a transfer device 115. The visualizing material image moved to the sheet medium moves from the photoconductive member 111 to a conveyor 141 in a separating device 116 together with the sheet medium and moves from the conveyor 141 to the fuser 1. Residual charges of the photoconductive member 111 and the remainder of the visualizing material are removed by a cleaner 117 and an electricity remover 118.

The visualizing material image integrated with the sheet medium by the fuser 1 passes through a conveying path 142 and is moved to the tray 121 using a roller set 143.

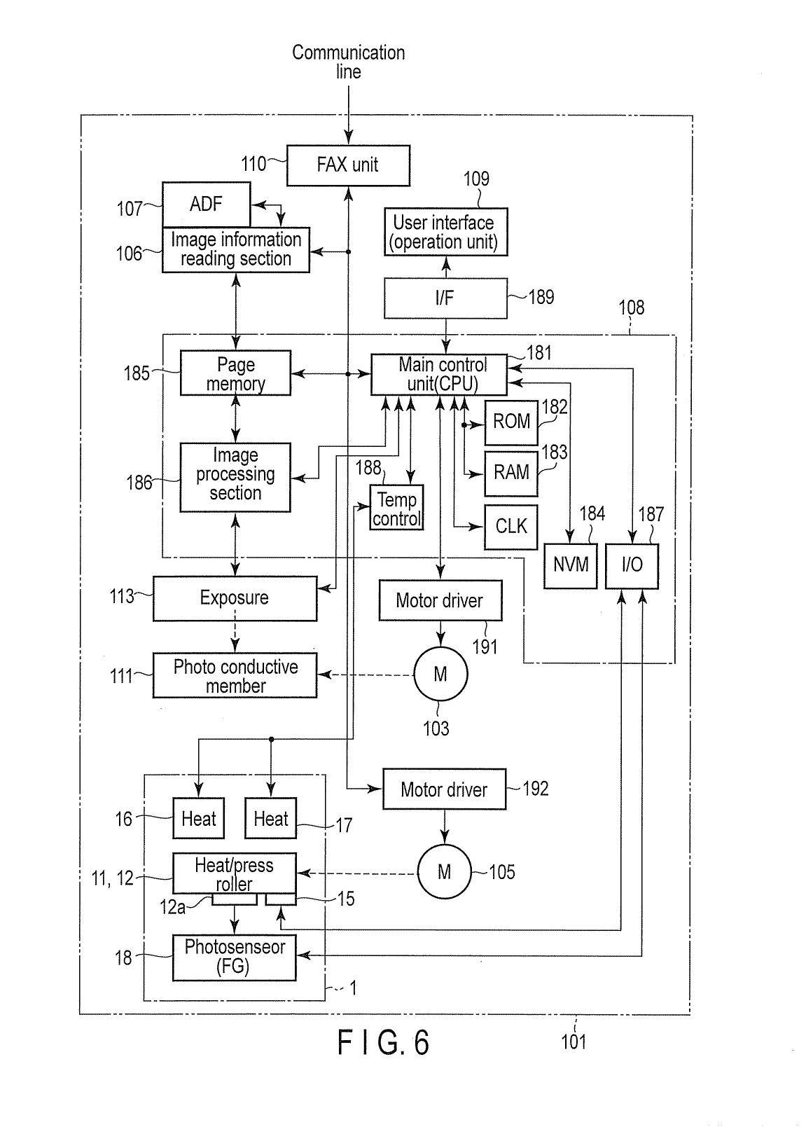

The heat roller 11 of the fuser 1 rotates at predetermined timing according to the rotation of a motor 105 (see FIG. 6) transmitted by a transmission mechanism 105a. A motor 103 (see FIG. 6) rotates the photoconductive member 111 using a transmission mechanism 103a.

As shown in FIGS. 1A and 1B, the press roller 12 acquires the rotation of the heat roller 11 in the nip and rotates. Therefore, the section (the position) of the press roller 12 is associated with the rotation of the press roller 12 and can be estimated on the basis of the rotation of the heat roller 11.

FIG. 5 shows an example of a roller-position informing and detecting mechanism configured to enable calculation of a cumulative total of heating times in each position of the press roller (a division (a section) that stops in the nip).

As shown in FIG. 5, a disc 12a in which a predetermined number of holes are opened is prepared, for example, at one end of the shaft of the press roller. Light is irradiated from one surface side of the disc 12a. The light passing through the holes of the disc 12a is received on the other surface side across the disc 12a. For example, the rotation and the stop of the press roller and a division (a section) that stops in the nip can be detected from a photointerrupter 18. Instead of the disc and the photointerrupter, an FG (frequency generator) may be integrally provided in the shaft. The disc and the photointerrupter or the FG may be provided in the heat roller.

An example of a control system for the fuser and the MFP shown in FIGS. 1A, 1B, 4, and 5 is explained with reference to FIG. 6.

The control section (the controller) 108 includes a main control device (a main control block/a CPU) 181. The CPU 181 includes at least a ROM 182, a RAM 183, an NVM (nonvolatile memory) 184, a page memory 185, an image processing section 186, an input and output section (I/O) 187, and a temperature control section 188.

The CPU 181 is connected to at least the image-information reading section 106, the exposing device 113, a motor driver 191, and a (fusing) motor driver 192. The CPU 181 is connected to the UI (the operation input section) 109 through an interface (I/F) 189.

The motor driver 191 controls the rotation (and the stop) of the drum motor 103 configured to rotate the photoconductive member 111. The (fusing) motor driver 192 controls the rotation (and the stop) of the motor 105 configured to rotate the heat roller 11 of the fuser 1. The CPU 181 calculates a stop position referring to a cumulative total stored by the NVM 184 and instructs the motor driver 192 to stop the motor 105. Stop positions and instruction values to the motor driver 192 are stored in the NMV 184, an external storage device, or the like in a table format.

The photo-interrupter (a sensor) 18 detects the rotation of the press roller 12, which rotates with the nip between the press roller 12 and the heat roller 11, i.e., the position of the press roller 12, which stops in the nip, through the disc 12a configured to inform the rotation.

The thermistor 15 detects the temperature of the heat roller 11. The CPU 181 detects an output of the sensor 18 (the press roller stop position) and an output of the thermistor 15 (the temperature of the heat roller 11) through the I/O (the input and output section) 187. The CPU 181 controls outputs of the heater lamps 16 and 17 through the temperature control section 188 and maintains the temperature of the heat roller 11 within a predetermined range.

The page memory 185 stores image information of an original document (fed by the ADF 107) captured by the image reading section 106. The image processing section 186 converts the image information stored by the page memory 185 into an image signal corresponding to exposure light (image exposure light) provided to the photoconductive member 111 by the exposing device 113 and supplies the image signal to the exposing device 113.

The NVM 187 stores at least an output of the sensor 18 (the press roller stop position) and, for example, the number of times of image formation and ready standby (unattended) time (a cumulative total of heating times) counted by firmware of the CPU 181. To count the ready standby (unattended) time, for example, a clock (CLK) can be used in the CPU 181. It goes without saying that, for example, an output of a clock section prepared in a facsimile unit (a FAX unit) 110 used for transmission and reception of facsimile can also be used.

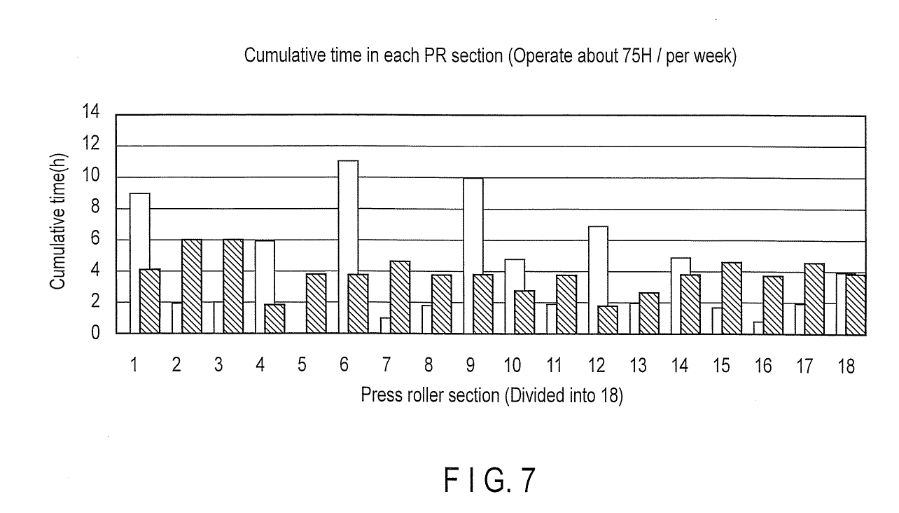

In FIG. 7, time in which each of divisions, which are obtained by dividing the outer circumference of the press roller into n (n is a positive integer, n=18), is located in the nip when the rotation ends (forms the nip when the rotation stops) is shown in each of cases in which the present proposal is applied and the present proposal is not applied.

In an example shown in FIG. 7, the fuser 1 is used in an NFP in which the diameter of a heat roller is set to 35 mm (cored bar thickness: 0.8 mm), the diameter of a press roller is set to 35 mm, inter-roller pressure is set to 150 N (Newton), nip with is set to about 6 mm, control temperature of the surface of the heat roller is set to 190° C., and circumferential speed of the heat roller is set to 210 mm/s and the number of output copies per unit time (minute) in the case of a sheet medium size A4 is forty-five. The fuser 1 in the example shown in FIG. 7 includes two divided heater lamps (wattage: 600 W each) including a center lamp configured to heat the center of the heat roller and a side lamp configured to heat an end of the heat roller and a 300 W auxiliary lamp configured to heat the entire heat roller (three lamps in total).

Compared with the example shown in FIG. 1, the example shown in FIG. 7 is different in the outer diameters (the diameters) of the rollers and in that the auxiliary lamp that is turned on during normal ready state is used.

As in FIG. 2, the cumulative heating time in FIG. 7 is shown for each of the cases in which the present proposal is applied and the present proposal is not applied. In the present proposal, heat deterioration in a press roller circumferential direction can be substantially uniformalized by dividing the outer circumference of the press roller by a distance at least larger than the width of the nip, i.e., an angle equivalent to the nip width (equally dividing the outer circumference into n at an angle equivalent to the nip width equal to or larger than the nip width, which is an angle with which the press roller circumference can be equally divided into an integer number) and starting an operation for stopping the press roller such that the press roller is located in the nip (forms the nip when the rotation stops) in a section where the cumulative heating time is the smallest when a print or pre-run operation (during warm-up or pre-run in each fused period) ends.

As it is seen from FIG. 7, when the present proposal is applied, heat deterioration in the press roller circumferential direction is substantially uniformalized. It is possible to prevent occurrence of a deficiency due to partial short life of the press roller. If a print volume is large, according to this operation, a traveling distance (the number of revolutions×outer circumference length) of the press roller increases. Therefore, as shown in FIG. 7, a degree of heat deterioration of the outer circumference of the press roller can be uniformalized by carrying out the operation every time a determined time (time in which heat deterioration of the press roller rubber in use is hardly accumulated, e.g., about one hour) elapses rather than every time.

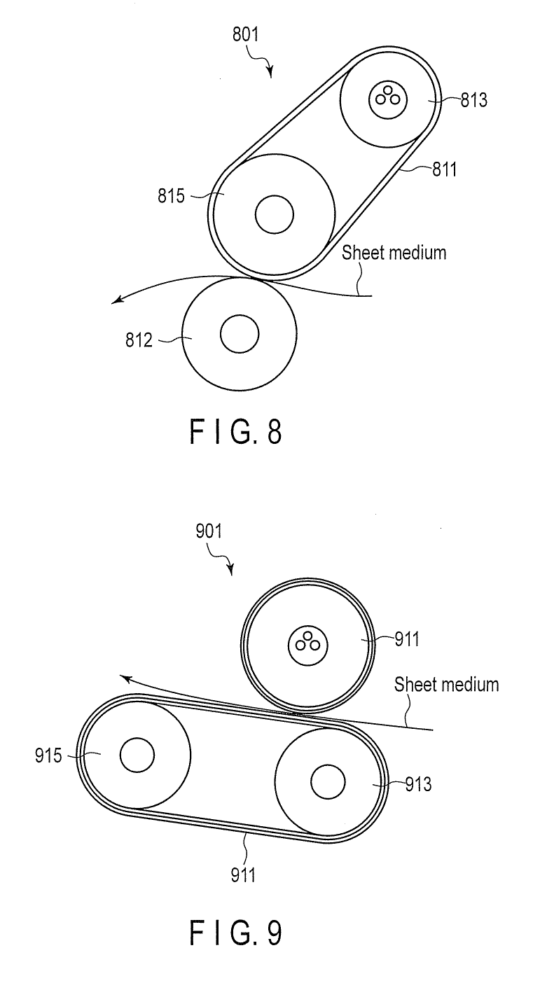

In the fuser 1, as shown in FIGS. 8 and 9, on one of the heat roller side and the press roller side, an endless belt may be located between two rollers.

For example, as shown in FIG. 8, the press roller 12 and a belt unit 801 are used.

The belt unit 801 includes a belt 811, a heat roller 813 including a heater lamp inside, and a pressure roller 815 configured to apply predetermined tension to the belt 811 in cooperation with the heat roller 813 and press the belt 811 against the press roller 12 at predetermined pressure. As the pressure roller 815, an elastic roller obtained by winding rubber having predetermined thickness around a shaft of metal similar to the press roller 12 can be used. In that case, as in the press roller 12, heat deterioration in a roller circumferential direction can be substantially uniformalized by dividing the outer circumference of the pressure roller 815 by a distance at least larger than the width of the nip, i.e., an angle equivalent to the nip width (equally dividing the outer circumference into n at an angle equivalent to the nip width equal to or larger than the nip width, which is an angle with which the pressure roller circumference can be equally divided into an integer number) and starting an operation for stopping the pressure roller such that the pressure roller is located in the nip (forms the nip when the rotation stops) in a section where the cumulative heating time is the smallest when a print or pre-run operation (during warm-up or pre-run in each fused period) ends. The heat roller 813 may be substantially the same as the heat roller 11 shown in FIG. 1.

In an example shown in FIG. 9, the heat roller 11 and a belt unit 901 are used.

The belt unit 901 includes a belt 911, a pressure roller 913 configured to support the belt 911 and apply predetermined pressure between the heat roller 11 and the belt 911, and a tension roller 915 configured to apply predetermined tension to the belt 911 in cooperation with the pressure roller 913. The pressure roller 913 may be substantially the same as the press roller 12 shown in FIG. 1.

In the fuser 1 explained with reference to FIG. 1, the heat roller 11 may be an elastic roller obtained by winding rubber having predetermined thickness around a shaft of metal. In this case, as in the press roller 12, heat deterioration in a roller circumferential direction can be substantially uniformalized by dividing the outer circumference of the heat roller 11 by a distance at least larger than the width of the nip, i.e., an angle equivalent to the nip width (equally dividing the heat roller circumference into n at an angle equivalent to the nip width equal to or larger than the nip width, which is an angle with which the heat roller circumference can be equally divided into an integer number) and starting an operation for stopping the heat roller such that the heat roller is located in the nip (forms the nip when the rotation stops) in a section where the cumulative heating time is the smallest when a print or pre-run operation (during warm-up or pre-run in each fused period) ends.

As explained above, by applying this embodiment, it is possible to suppress a material of an elastic member (a roller) for forming a nip from being deteriorated by being stopped for a long time in a state in which the nip is fused. In other words, it is possible to reduce a situation in which local deterioration of the material (the roller) of the elastic member occurs and undesired abnormal sound during driving, a local fusing failure, and the like occur in relation to accumulation of image formation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A fuser comprising:
an endless member, an endless section of which moves in a rotating direction of a rotating shaft according to rotation of the shaft;
a pressing cylindrical member which applies predetermined pressure to the endless section of the endless member; and
a controller configured to detect a rotation angle of the pressing cylindrical member, the controller detecting, with a rotation angle equivalent to a nip region where the pressing cylindrical member and the endless section comes into contact with each other and are elastically deformed set as a minimum unit of the rotation angle, a rotation angle for dividing an outer circumference of the pressing cylindrical member with an integer.

2. The fuser of claim 1, wherein the controller is integrated with a rotation center of the pressing cylindrical member and detects an angle between a reference position of the pressing cylindrical member and the outer circumference that stops in the nip region.

3. The fuser of claim 2, wherein the controller manages, as a number of sections divided by an integer, the outer circumference of the pressing cylindrical member between the reference position of the pressing cylindrical member detected by the controller and the outer circumference that stops in the nip region.

4. The fuser of claim 3, wherein the controller accumulates, for each of the sections, time in which the section stops in the nip region.

5. The fuser of claim 4, wherein the controller changes, on the basis of a result of the accumulation, the section that stops in the nip region if the pressing cylindrical member stops.

6. The fuser of claim 1, wherein the controller manages, as a number of sections divided by an integer, the outer circumference of the pressing cylindrical member between the reference position of the pressing cylindrical member detected by the controller and the outer circumference that stops in the nip region.

7. The fuser of claim 6, wherein the controller accumulates, for each of the sections, time in which the section stops in the nip region.

8. The fuser of claim 7, wherein the controller changes, on the basis of a result of the accumulation, the section that stops in the nip region if the pressing cylindrical member stops.

9. An image forming apparatus comprising:
a visualizing section which selectively supplies a visualizing material to image information to visualize the image information;
a transfer section which moves the image information visualized by the visualizing section onto a sheet;
a visualizing-material fusing section which fuses the image information moved by the transfer section on the sheet includes,
an endless member, an endless section of which moves in a rotating direction of a rotating shaft according to rotation of the shaft;
a pressing cylindrical member which applies predetermined pressure to the endless section of the endless member; and
a controller configured to detect a rotation angle of the pressing cylindrical member, the controller detecting, with a rotation angle equivalent to a nip region where the pressing cylindrical member and the endless section comes into contact with each other and are elastically deformed set as a minimum unit of the rotation angle, a rotation angle for dividing an outer circumference of the pressing cylindrical member with an integer.

10. The image forming apparatus of claim 9, wherein the controller is integrated with a rotation center of the pressing cylindrical member and detects an angle between a reference position of the pressing cylindrical member and the outer circumference that stops in the nip region.

11. The image forming apparatus of claim 10, wherein the controller manages, as a number of sections divided by an integer, the outer circumference of the pressing cylindrical member between the reference position of the pressing cylindrical member detected by the controller and the outer circumference that stops in the nip region.

12. The image forming apparatus of claim 11, wherein the controller accumulates, for each of the sections, time in which the section stops in the nip region.

13. The image forming apparatus of claim 12, wherein the controller changes, on the basis of a result of the accumulation, the section that stops in the nip region if the pressing cylindrical member stops.

14. The image forming apparatus of claim 9, wherein the controller manages, as a number of sections divided by an integer, the outer circumference of the pressing cylindrical member between the reference position of the pressing cylindrical member detected by the controller and the outer circumference that stops in the nip region.

15. A method to stop a rotational member comprising:
detecting a rotation angle of a pressing cylindrical member which rotates, in a region where the pressing cylindrical member comes into contact with an endless section of an endless member which moves according to rotation of a rotating shaft, around the rotating shaft with thrust from the endless member and apply predetermined pressure to the endless section of the endless member;
calculating, on the basis of the detected rotation angle of the pressing cylindrical member, a number of sections obtained by dividing, by an integer, an outer circumference of the pressing cylindrical member with a rotation angle equivalent to a region elastically deformed from a reference position of the pressing cylindrical member set as a minimum unit;
accumulating times in which the respective sections stop in the elastically deformed region; and
uniformalizing times in which the respective sections stop in the elastically deformed region.

16. The method to stop a rotational member of claim 15, further comprising changing, in order to uniformalize the times in which the respective sections stop in the elastically deformed region, according to the calculated number of sections, a section that stops in the elastically deformed region.

17. The method to stop a rotational member of claim 16, wherein the change is applied to a section where a cumulative total of times in which the respective sections stop in the elastically deformed region is a minimum.

18. The method to stop a rotational member of claim 15, wherein in the accumulating times, if a section that stops in the elastically deformed region is integrated with a section adjacent to the section, times in which the sections stop are accumulated in the respective sections.

19. The method to stop a rotational member of claim 18, further comprising:
changing, in order to uniformalize the times in which the respective sections stop in the elastically deformed region, according to the calculated number of sections, a section that stops in the elastically deformed region.
